(19) United States
(12) Patent Application Publication
(10) Pub. No.: US 2015/0145257 A1
(43) Pub. Date: May 28, 2015

(54) ENERGY GENERATING APPARATUS FOR GAS OR LIQUID FLOWING CONDITIONS

(71) Applicant: Bryan P. Hendricks, Big Piney, WY (US)

(72) Inventor: Bryan P. Hendricks, Big Piney, WY (US)

(21) Appl. No.: 14/553,370

(22) Filed: Nov. 25, 2014

Related U.S. Application Data
(60) Provisional application No. 61/908,264, filed on Nov. 25, 2013.

(51) Int. Cl. F01D 15/10; H02K 7/18

(52) U.S. Cl. CPC F01D 15/10; H02K 7/1823
USPC 290/52

(57) ABSTRACT

An in-line energy generating system for a fluid passing there through where the system has a tubular turbine having an internal bore that includes at least one helical groove defined by an indented portion and a raised portion, whereby the kinetic energy of the fluid flowing through the helical groove drives the generally tubular turbine in a rotational manner at least in part by the frictional force exerted by the fluid as it flows through the helical groove, and a magnetic portion for inducing electrical current in an induction coil positioned around the turbine within the housing.

### CORRESPONDING PATENT APPLICATIONS

The present application takes priority from provisional application Ser. No. 61/908,264 filed Nov. 25, 2013, the entire contents of which are incorporated herein in its entirety by reference.

### BACKGROUND

The embodiments herein relate generally to in-line an apparatus for generating energy and, more specifically, to an energy generating apparatus employing a turbine driven by an internal spiraling flow of fluid passing there through

In the oil and gas industry, there is a need for energy generating devices on the site. Alternative power generating systems and apparatuses that use natural elements such as wind and solar energy have many limitations. For example, wind and solar energy are not continually present, which causes downtime and inefficient operation of the power generating systems and devices.

Currently, turbine meters exist, which directly connect to oil and gas pipes. However, these devices are limited to detecting and measuring the flow of oil or gas through the pipes. Therefore, the devices do not generate or capture electrical current from the flow of gas or liquid through the pipes. Current devices simply measure flow volumes.

As such, there is a need in the industry for an energy generating apparatus that effectively operates under gas or liquid flowing conditions and comprises minimal moving parts to enable the smooth operation, longevity and reliability of the device.

### SUMMARY

In some embodiments of the present invention, an in-line energy generating system is provided for converting kinetic energy of fluid flowing through the system into electrical energy. The term fluid covers both a gas or a liquid, or both. The housing preferably comprises a first end and second end, each configured to connect to a fluid source and a fluid sink, respectively. The ends may be configured as mechanical connectors, such as a flanged connection, although types of connections are contemplated.

The system comprises a generally tubular turbine rotatably supported within a housing, the generally tubular turbine having an internal bore longitudinally positioned there through so as to permit the flow of fluid though the internal bore and to permit the generally tubular turbine to absorb at least some of the kinetic energy of the fluid as it passes through the internal bore during operation. The internal bore comprises an inflow end, an outflow end, and a helical groove in the radial wall of the generally tubular turbine, with the groove being defined by an indented portion and a raised portion. The helical groove preferably defines a continuous helical pathway and is configured to direct at least a part of the fluid flowing through the internal bore, whereby the kinetic energy of the fluid flowing through the helical groove drives the generally tubular turbine in a rotational manner at least in part by the frictional force exerted by the fluid as it flows through the helical groove from the inflow end of the generally tubular turbine to the outflow end. The generally tubular turbine further comprises a magnetic region proximate an external face of the generally tubular turbine so that the magnets can induce electrical current in an induction coil positioned around the generally tubular turbine within the housing when the generally tubular turbine rotates during operation.

In some embodiments, the internal bore comprises a plurality of helical grooves. In some embodiments, the magnetic region of the generally tubular turbine may comprise a plurality of magnets positioned generally circumferentially about the generally tubular turbine.

### BRIEF DESCRIPTION OF THE FIGURES

A detailed description of embodiments of the invention is provided below with reference to the accompanying figures, wherein the figures disclose one or more embodiments of the present invention.

FIG. 1 shows a front perspective view of certain embodiments of an in-line energy generating system;

FIG. 2 shows a rear perspective view of the embodiments of FIG. 1;

FIG. 3 shows a cross-sectional view of certain embodiments of FIG. 1 along line A-A;

FIG. 4 shows a cross-sectional view of certain embodiments of FIG. 2 along line B-B;

FIG. 5 shows a top view of the embodiments of FIG. 1;

FIG. 6 shows a side view of the embodiments of FIG. 1;

FIG. 7 shows an exploded view of the embodiments of FIG. 1.

FIG. 8 shows a cross-sectional view of alternative embodiments;

FIG. 9 shows a front perspective view of alternative embodiments of an in-line energy generating system;

FIG. 10 shows a perspective cross-sectional view of certain embodiments of FIG. 9 along line C-C; and

FIG. 11 shows a cross-sectional view of certain embodiments of FIG. 9 along line D-D;

### DETAILED DESCRIPTION OF CERTAIN EMBODIMENTS

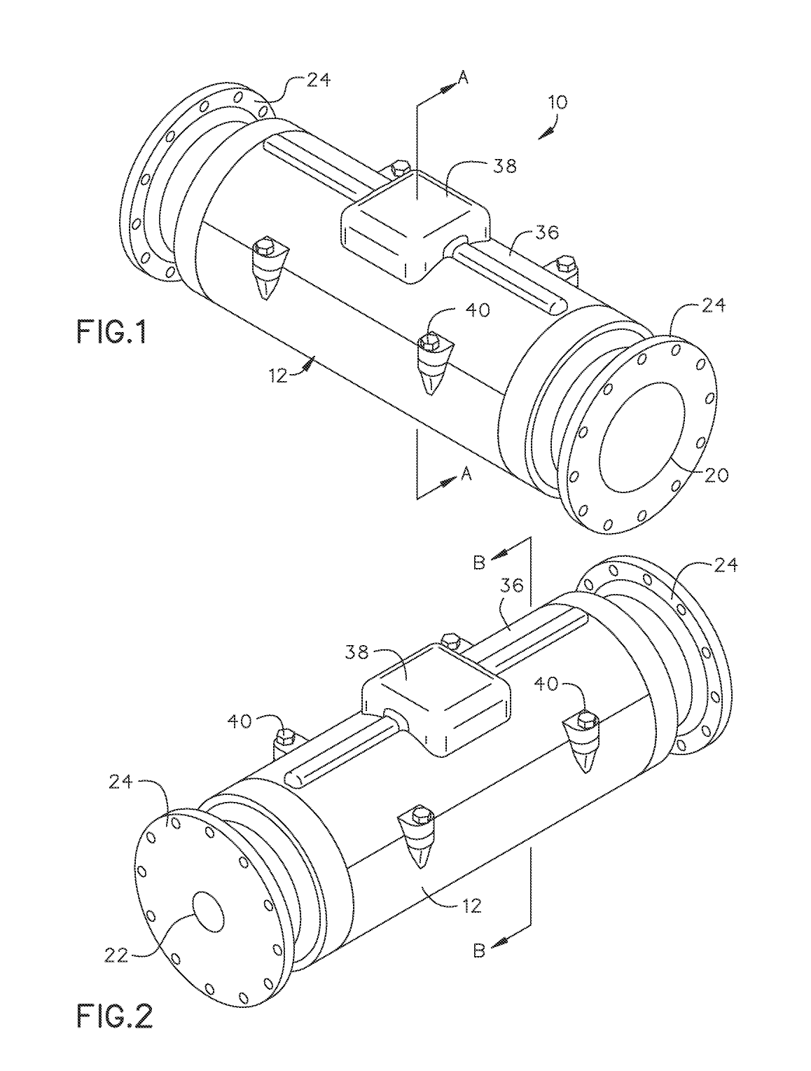

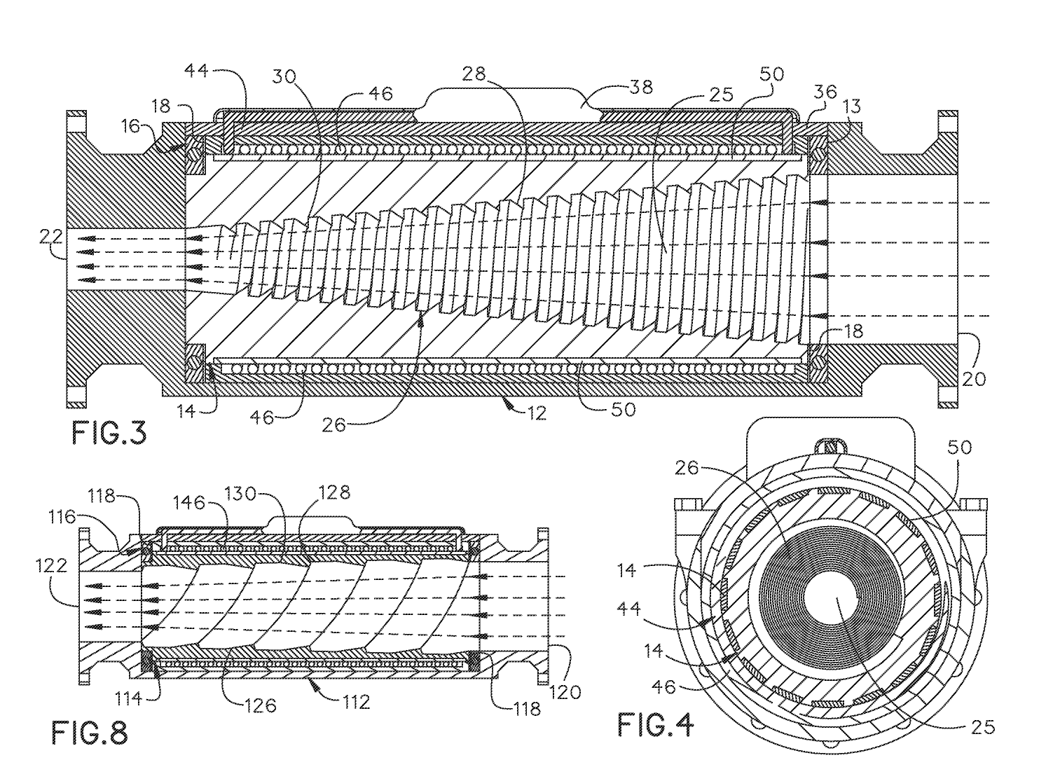

As shown in FIGS. 1 and 3, some embodiments of the in-line energy generating system comprise an in-line energy system 10 comprising a housing 12 having an internal cavity 13 therein to enclose a rotatable turbine 14 supported at opposing ends by bearings 16 with associated seals 18. The housing is configured, as described below, to have an inflow end 20 and an outflow end 22, and to be connectible via mechanical fittings 24, for example flanges, within an existing fluid flow system, such as a pipeline (not shown) in which fluid is flowing there through.

The turbine 14, which may be generally cylindrical in shape or tapered if so desired, comprises an internal bore 25 that is in fluid communication with the inflow and outflow ends of the housing 20, 24. The internal bore 25 comprises one or more spiral or helical grooves 26 between an inflow end and an outflow end of the turbine 14. The groove or grooves 26 may extend entirely from the inflow end 20 to the outflow end 24 of the turbine, or it may not, one end to the other. Where there are multiple grooves employed, it is preferably that they be arranged concentrically to each other; i.e., overlapping but axially displaced from each other. The discussion herein with respect to a single helical or spiral groove preferably applies to each helical or spiral groove where there is more than one.

As shown in FIG. 3 specifically, the helical groove 26 comprises an indented portion 28 and a raised portion 30, which combine to direct at least a portion of the fluid flowing through the turbine 14 through the helical groove 26. The fluid flowing through the groove thereby impacts a rifling dynamic force upon the turbine 14 during operation, which causes the turbine 14 to rotate about its bearings 16 within the housing 12. An alternative arrangement of helical or spiral grooves is discussed below in association with FIG. 8. It should be noted that in some embodiments the internal bore 25 is tapered, as shown in FIG. 3, but need not be. Where the internal bore 25 is tapered, the outflow port 22 of the system housing 12 may be smaller than the inflow port 20. Where the internal bore is not tapered, however, it is preferable to maintain an equal size set of inflow and outflow ports. The configuration and size of the indented and raised portions 28, 30 of the helical or spiral groove(s) 26 is preferably configured to permit an efficient transfer of fluid kinetic energy into mechanical spiraling energy of the turbine as discussed further below.

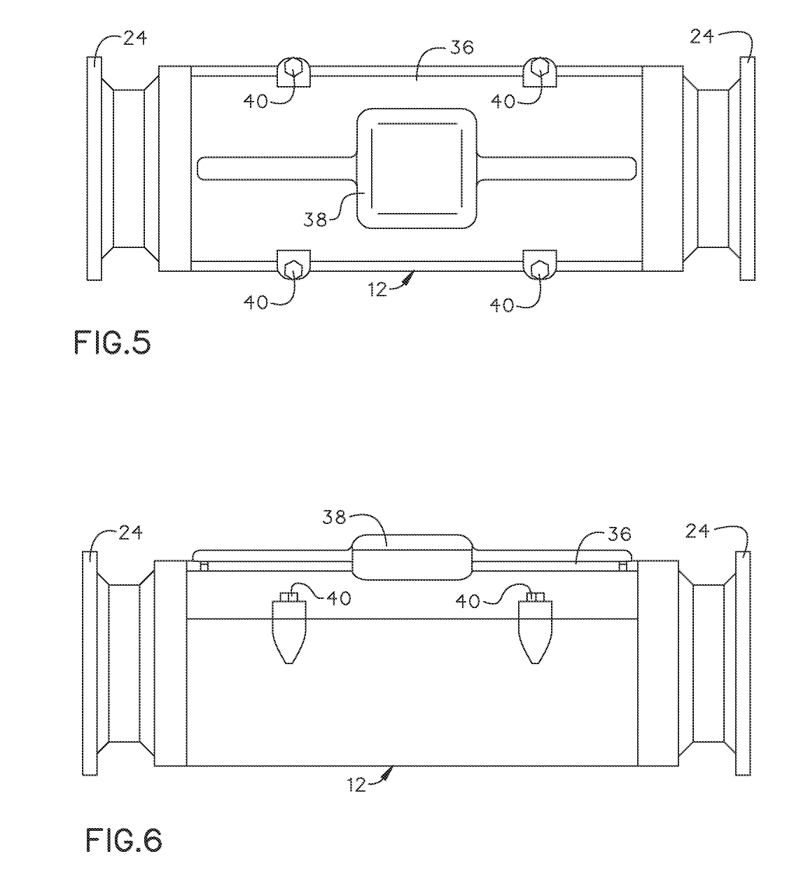

Referring back to FIGS. 1-2 and 5-6, the housing 12 comprising mechanical fittings 24, inflow end 20, outflow end 22, lid 36, and lid box 38. Lid 36 and lid box 38 may be affixed to body housing 12 using lid mechanical fasteners 40 of one of many types. In one embodiment, body housing 12 is placed within a pipe carrying a fluid such as natural gas or oil. The system, once positioned in-line, permits the fluid to flow through inflow port 20, through the turbine 14, and out the outflow port 22. It shall be appreciated that the diameters of the housing and its features may vary as desired to accommodate the particular in-line placement and the exigent conditions (including fluid temperature, flow rate and pressure) that the present inventive embodiments are intended to withstand.

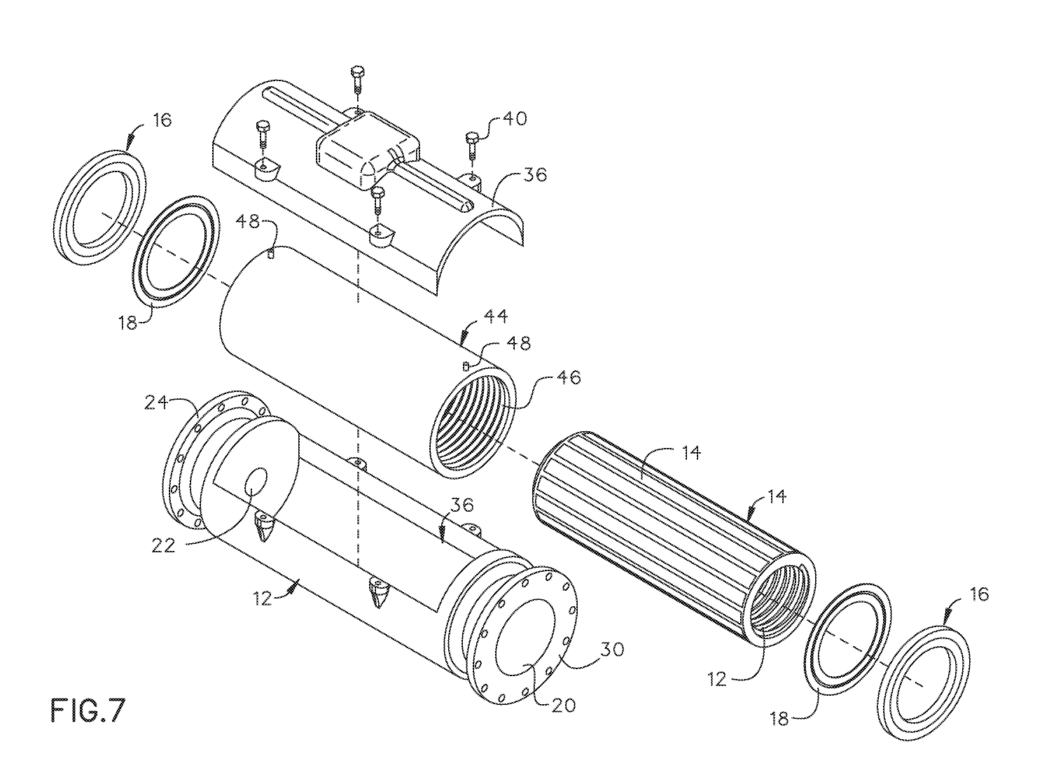

As shown in FIGS. 3-4 and 7, the housing 12 preferably also comprises a coil housing 44 surrounding concentrically the turbine 14 to house an induction coil 46 therein. In one embodiment, the leads of the induction coil 46 may project through the lid 36 as shown at 48 in FIG. 7. In some embodiments, coil 46 comprises one or more windings of copper wire or other suitable material that are wound throughout the coil housing 44 so as to surround the turbine 14. The turbine 14 further comprises a magnetic portion, for example a plurality of radially-spaced magnets 50 disposed about the outer circumference of the turbine so that when the turbine 14 rotates within housing 12 an electrical current is induced by the magnets within the induction coil 46, thereby generating electrical power that can be tapped by the user in a manner so desired. The magnets 50 may be directed exposed or embedded somewhat within the turbine 14, and can be configured in one or more of any possible size and configuration depending upon the desired electromechanical output desired.

The in-line system may be employed to store energy for later transmission or to power an apparatus. The bearings 16 centralize turbine 14 within coil housing 44 and allow the turbine to rotate freely without contacting coil 46 and the interior of coil housing 44. It shall be appreciated that the seals 18 prevent the fluid from flowing into the coil housing 44. Where the turbine is tapered, the corresponding coil housing and coil may be appropriate tapered as well to maintain close proximity of the magnet to induction coil.

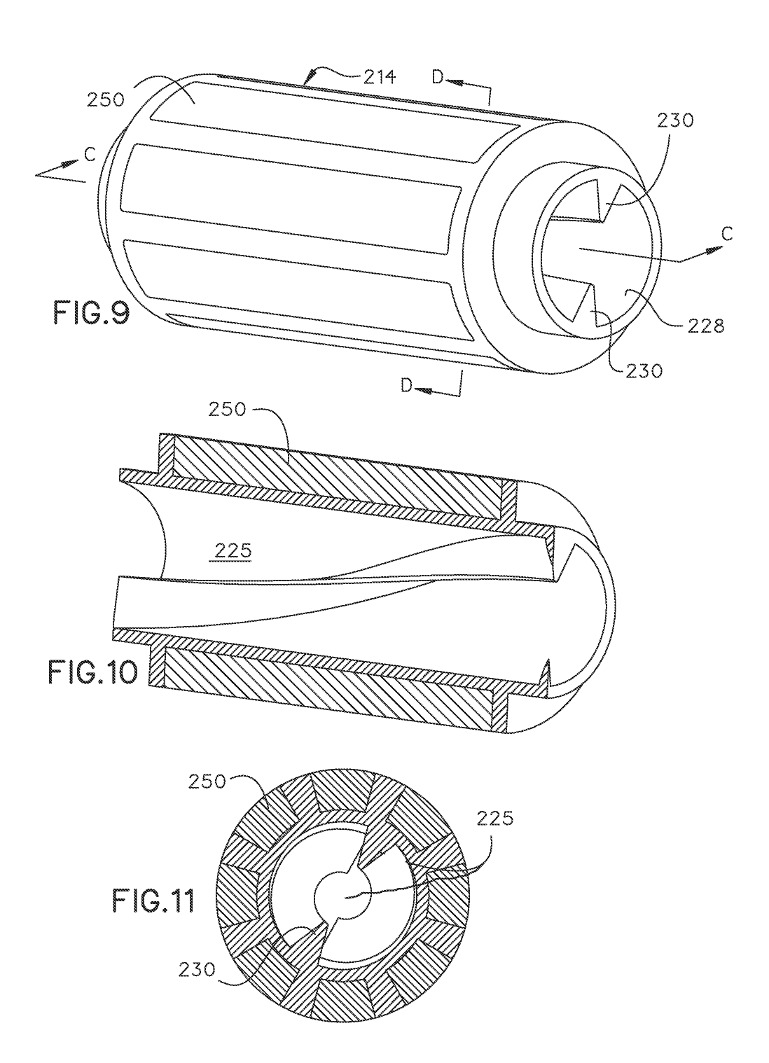

The spiral grooves 26 should be configured and sized, with the appropriate materials, to convert the fluid kinetic energy to mechanical energy for rotation of the turbine, which in turn induces electrical power. The possible arrangements and configurations of turbines and grooves, including configuration and size of the indented and raised portions of the groove(s) is contemplated to vary widely depending upon its intended use and the expected exigent conditions of operation. In that regard, one of a number of possible alternative turbine embodiments is shown in FIG. 8. As shown, the configuration of the indented portion 128 and raised portion 130 of the indented bore 126 is different to reflect different fluid conditions. It may be that a more gradual, less severe, angle is effective at converting kinetic energy to mechanical energy. Indeed, it is also considered that the configuration of FIGS. 9-11 may be effective in some fluid conditions. In the regard, with reference to such figures, an alternative system 210 comprises a turbine 214 having an internal bore 226 extending between an inflow end and outflow end. In one example of such alternative embodiments, the internal bore 225 comprises one or more internal grooves 226 that is defined by a radially extended indented portion 228 and an almost blade-like raised portion 230. As with the earlier embodiments, the turbine comprises a magnetic portion that, for example, may comprise a plurality of radially-spaced magnets 250.

It shall be appreciated that the components of the energy generating apparatus described in several embodiments herein may comprise any known materials in the field and be of any color, size and/or dimensions. For example, components may be made from any combination of materials including, but not limited to, steel, alternative steel materials, carbide, aluminum, copper, or the like. It shall be appreciated that the components of the apparatus described herein may be manufactured and assembled using any known techniques in the field. While the embodiments herein describe the energy generating apparatus for use with pipes in the gas and oil industry, it shall be appreciated that the apparatus may be used in other applications such as rivers, waterways, or any other location having gas or liquid flowing conditions.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An in-line energy generating system for converting kinetic energy of fluid flowing through the system into electrical energy, the system comprising a generally tubular turbine rotatably supported within a housing, the generally tubular turbine having an internal bore longitudinally positioned there through so as to permit the flow of fluid though the internal bore and to permit the generally tubular turbine to absorb at least some of the kinetic energy of the fluid as it passes through the internal bore during operation, the internal bore comprising an inflow end, an outflow end, and a helical groove in the radial wall of the generally tubular turbine, the groove being defined by an indented portion and a raised portion, the helical groove defining a continuous helical pathway and configured to direct at least a part of the fluid flowing through the internal bore, whereby the kinetic energy of the fluid flowing through the helical groove drives the generally tubular turbine in a rotational manner at least in part by the frictional force exerted by the fluid as it flows through the helical groove from the inflow end of the generally tubular turbine to the outflow end, the generally tubular turbine further comprising a magnetic region proximate an external face of the generally tubular turbine so that the magnets can induce electrical current in an induction coil that can be positioned around the generally tubular turbine within the housing when the generally tubular turbine rotates during operation.

2. The in-line energy generating system of claim 1, further comprising an induction coil positioned within the housing.

3. The in-line energy generating system of claim 1, wherein the internal bore comprises a plurality of helical grooves.

4. The in-line energy generating system of claim 1, wherein the magnetic region of the generally tubular turbine comprises a plurality of magnets positioned generally circumferentially about the generally tubular turbine.

5. The in-line energy generating system of claim 1, wherein the housing comprises a first end and second end, each configured to connect to a fluid source and a fluid sink, respectively.
